(19) United States
(12) Patent Application Publication
(10) Pub. No.: US 2010/0216379 A1
(43) Pub. Date: Aug. 26, 2010

(54) SEAFOOD UTENSIL

(76) Inventor: Jane A. LITTLE, Pt. Pleasant, WV (US)

Correspondence Address: FITCH, EVEN, TABIN & FLANNERY, P. O. BOX 18415, WASHINGTON, DC, 20036, US

(21) Appl. No.: 12/389,990

(22) Filed: Feb. 20, 2009

(51) Int. Cl. A22C 29/02

(52) U.S. Cl. 452/6; 81/418; 30/120.1

(57) ABSTRACT

A shellfish utensil with a handle portion and at least one substantially circular disk attached at one end of the handle portion. The diameter of the disk is configured to be less than the diameter of an exoskeleton section of the shellfish appendage. Optionally the utensil can have a second substantially circular disk of a different diameter to the disk attached at a second end of the handle portion, or even come in a set having various diameters of between, for example, 0.5 and 1.25 centimeters. The disk can be attached to the handle at the center of the disk or at the edge. Alternate embodiments of the present invention can optionally include scissors, hook blades, crab crackers, and the like.

### FIELD OF THE INVENTION

The present invention generally relates to utensils for eating shellfish, and more particularly, without limitation, to a novel shellfish utensil configured to extract meat from a crab or lobster.

### BACKGROUND OF INVENTION

Shellfish, such as crab and lobster, are frequently cooked by boiling or steaming. The meat is then served while still in its shell. Thus, eating a shellfish is typically a difficult process because the shell has to be opened before the meat can be removed. Since the shell remains hard, even after cooking, opening it requires the user or remove the shell using their hands or various devices known in the art. Typically, such devices involve some sort of item for tearing, ripping, crushing, or cutting the shell.

Current methods of opening a shellfish shell and extracting meat require the use of multiple but simple tools. A basic nut-cracker type shell opening device typically having two handles hinged together allow a user to hold and grip the shell being cracked when the user exerts pressure on the handles. See U.S. Pat. No. 7,261,627 to Sellars, Jr. et al. Other utensils can include small hammers, small forks, hooks, blades, scissors, and the like. These utensils can be costly, especially for restaurants, due to the high volume needed for its patrons. Also, due to the force needed to open the shell, such items are typically made from metal, therefore not disposable.

Also known in the art are devices that have a combination of these devices. See generally, Sellars, Jr. et al. and U.S. Pat. No. 6,503,137 to Maille. The Sellars, Jr. utensil combines a prying blade, a ripping blade with a slot, a prying tip, and a handle portion that can be used to crack open a shell.

Whiles these inventions show advances in the art, there remains a desire and a need in the art to provide a simple shellfish utensil suitable for application on the limbs of shellfish such as crabs or lobster. Such utensil could be disposable or simple in construction and design or in combination with other utensils known in the art.

### SUMMARY OF INVENTION

Accordingly, the present invention provides a simple shellfish utensil suitable for removing shellfish meat. The present invention can be easy to manufacture and made from disposable and inexpensive materials. The present invention may also be combined with other shell fish utensils known in the art.

Specifically, the present shellfish utensil has a handle portion and at least one substantially circular disk attached at one end of the handle portion. The diameter of the disk is configured to be less than the diameter of an exoskeleton section of the shellfish appendage. Optionally the utensil can have a second substantially circular disk of different diameters to the disk attached at a second end of the handle portion, or even come in a set having various diameters of between, for example, 0.5 and 1.25 centimeters. The disk can be attached to the handle at the center of the disk or at the edge.

Alternate embodiments of the present invention can optionally include scissors, hook blades, crab crackers, and the like.

Other features of the present invention will become more apparent to persons having ordinary skill in the art to which the present invention pertains from the following description and claims.

### BRIEF DESCRIPTION OF THE FIGURES

The foregoing features, as well as other features, will become apparent with reference to the description and figure below, in which like numerals represent elements and in which:

FIG. 1 illustrates a perspective view of two embodiments of a seafood utensil according to the present invention.

FIG. 2 illustrates a side view of one embodiment of a seafood utensil according to the present invention in use.

FIG. 3 illustrates a side view of an alternate embodiment of a seafood utensil according to the present invention.

FIG. 4 illustrates a side view of an alternate embodiment of a seafood utensil according to the present invention.

### DETAILED DESCRIPTION OF THE INVENTION

The present invention provides a shellfish utensil suitable for removing shellfish meat. The present invention can be easy to manufacture and made from disposable and inexpensive materials, such as plastics, composites, metal, carbon fiber, and other suitable materials known in the art. The present invention may also be combined with other shell fish utensils.

Generally, the present invention facilitates the opening of joints of a crab leg and, once opened, to push the crab meat the out of other end. While utensils are known in the art for this purpose, it is unknown to use a device, alone or in combination with other seafood utensils, to push the meat out an end of a crab appendage.

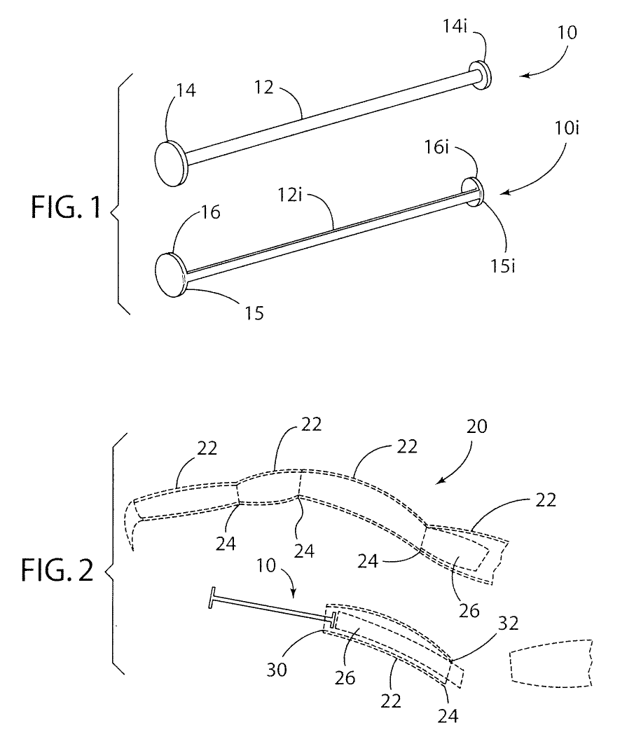

Referring now to the drawings, the invention is described in more detail. Referring to FIG. 1, a seafood utensil, generally shown as embodiments 10 and 10i, are illustrated for facilitating the extraction of meat from an appendage of a crustacean shellfish, such as leg of a crabs or lobsters. Utensil 10 and 10i include a handle portion 12 and 12i respectively having at least one substantially circular disk at one and typically a second substantially circular disk of a different diameter at handle 12 and 12i's second end. As shown in utensil 10, the disk 14 and 14i are attached to handle 12 at a central point of the disk (i.e., a point that is at an equal distance from all of the points on its circumference). Handle 12 and 12i can be of various lengths such as, for example, around 10 to 15 centimeters. Disk diameter can range from approximately 0.5 centimeters to about 1.25 centimeters and the present invention can be sold as a set with multiple utensils of various diameters. Disk diameter is configured to allow insertion into various diameters of an appendage of a crustacean limb such as the leg of a crab. Utensil 10i differs slightly in the attachment point of its disks 16 and 16i. As shown, handle 12i is attached to an edge of disk 15 and 15i. In this application, manufacturing could be cheaper for metal embodiments of the utensil in that it could be die stamped from rolled sheet metal.

Utensil 10 or 10i can be made from a variety of rigid materials such as composites, plastics, wood, metal, and the like. Material selection is based on sound engineering principles and selected from materials typically used for eating utensils. Cost and waste disposal should also considered.

FIG. 2 illustrates utensil 10 in use. As described, the present invention can be used for appendages of crustaceans such as crabs and lobsters, such as their swimming legs, walking legs, and chelipeds (pincers and claws). Each appendage has several tubular exoskeleton sections with hinged joints. For example, FIG. 2 illustrates a walking leg of a crab, generally indicated at 20. Crab leg 20 has tubular sections of exoskeleton 22 having hinged joints 24. Disposed within the sections of exoskeleton is the crab meat 26 to be eaten. In use, one disk 14 or 14i is used to pry the joints 24 apart. Alternative methods of opening the joint are possible, such as by using scissors, knifes, or crab crackers. When both joint ends are opened, a disk having a smaller diameter relative to the exoskeleton tubular section is pushed through an opening 30 thereby forcing the meat out the second opening 32.

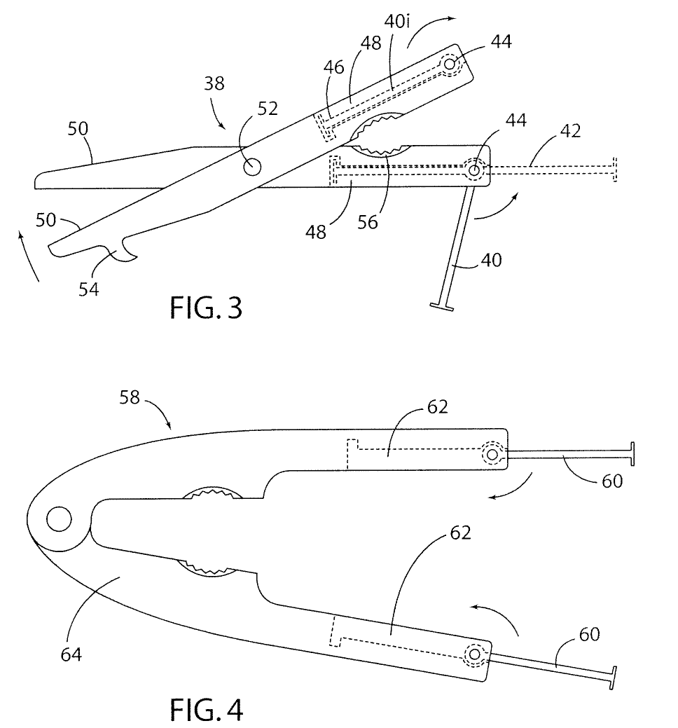

FIGS. 3 and 4 show the present invention in combination with other tools useful for assisting a diner eating crabs. In FIG. 3 a combination utensil 38 has a utensil of the present invention indicated at 40 and 40i. As shown, utensil 40 is rotatably connected at 44 to a fully extended position (at 42) or to a retracted position (at 46). In its retracted position, utensil 40 and 40i are disposed within a recessed cavity 48. Other utensils are added to aid in extracting crustacean meat. As shown, utensil 38 also has scissor blades rotatably attached at 52, a bladed hook 54, and a ‘crab cracker’ jaws 56. FIG. 4 shows a combination utensil 58 of the present invention having utensil 60 retatably disposed in recesses 62 within handles of a ‘crab cracker’ 64.

While the invention has been described in conjunction with specific embodiments, it is evident that many alternatives, modifications, and variations will be apparent to those skilled in the art in light of the foregoing description. Accordingly, the present invention attempts to embrace all such alternatives, modifications, and variations that fall within the spirit and scope of the appended claims.

1. A seafood utensil for facilitating the extraction of meat from an appendage of a crustacean shellfish, comprising:
a handle portion; and
at least one substantially circular disk attached perpendicular to an axis of the handle at one end of the handle portion, wherein a diameter of the disk configured to be less than the diameter of an exoskeleton section of the shellfish appendage.

2. The utensil of claim 1, further comprising a second substantially circular disk attached perpendicularly to the axis of the handle at a second end of the handle portion of a different diameter to the at least one substantially circular disk.

3. The utensil of claim 1, wherein the disk is attach to the handle portion at a central point of the disk.

4. The utensil of claim 1, wherein the disk is attached to an edge of the disk.

5. The utensil of claim 2, wherein the handle is between 10 to 15 centimeters in length.

6. The utensil of claim 1, wherein the disk diameter is between 0.5 centimeters to about 1.25 centimeters.

7. The utensil of claim 1, further comprising:
a first scissor arm having a first end rotatably attached to the utensil, the first scissor arm having a cavity to accept the utensil in a retracted position, a second end of the first scissor arm having a blade;
a second scissor arm rotatably connected to the first scissor arm, having a first end rotatably attached to a second utensil, the second utensil having a disk of a diameter different than the first utensil, the second scissor arm having a cavity to accept the second utensil in a retracted position, a second end of the second scissor arm having a second blade positioned in opposition to the blade;
a fixed cutting hook attached on said second scissor arm; and
adjacent ‘crab cracker’ jaws disposed on the opposite end of each scissor arm blade.

8. (canceled)
